(19) United States
(12) Patent Application Publication
(10) Pub. No.: US 2025/0387856 A1
(43) Pub. Date: Dec. 25, 2025

(54) METHOD AND DEVICE FOR THE DYNAMIC POSITIONING OF A PLURALITY OF LASER BEAMS ON A TARGET PLANE

(71) Applicant: Fraunhofer-Gesellschaft zur Föerderung der angewandten Forschung e.V., Muenchen (DE)

(72) Inventors: Christian VEDDER, Aachen (DE); Oskar HOFMANN, Essen (DE); Georg KÖNIG, Aachen (DE)

(21) Appl. No.: 18/879,304

(22) PCT Filed: Jun. 19, 2023
(86) PCT No.: PCT/EP2023/066423

§ 371 Date: Dec. 27, 2024

(30) Foreign Application Priority Data
Jun. 28, 2022 (DE) 10 2022 116 040.8

(51) Int. Cl. B23K 26/082; B23K 26/06; B23K 26/066; B23K 26/067

(52) U.S. Cl. CPC B23K 26/082; B23K 26/0643; B23K 26/066; B23K 26/067

(57) ABSTRACT

A device for the dynamic positioning of a plurality of laser beams (2) on a target plane (5) has at least one dynamic deflection device (3), with which the laser beams (2) can be directed onto the target plane (5) and guided over a respective area of the target plane (5). The dynamic deflection device (3) has an arrangement (9) of a plurality of single-axis and/or dual-axis microscanners (10), each of which can be controlled independently of one another. The number of microscanners (10) is selected and the laser beams (2) are guided in the arrangement (9) such that each laser beam (2) is directed onto the target plane (5) by way of a different microscanner (10). The microscanners (10) have mirrors with an oval or rectangular mirror shape, and are arranged such that, in a zero position of the microscanners (10), a long axis of the oval or rectangular mirror shape lies in a plane of incidence of the laser beam (2) that is incident on the respective microscanner (10).

### TECHNICAL FIELD OF APPLICATION

The present invention relates to a device for the dynamic positioning of a plurality of laser beams on a target plane, which device has at least one dynamic deflection device, with which the laser beams can be directed onto the target plane, and guided over a respective area of the target plane. The invention also relates to a corresponding method that can be implemented with the device.

In laser material processing, the available laser power of the laser beam source used is often higher than the power that can be effectively utilised for the processing with a laser beam. One possible manner in which the available laser power can be utilised efficiently is to split the original laser beam into two, or a plurality of, sub-beams with correspondingly lower individual powers. Here, however, the correct positioning on the target plane, in particular on a workpiece that is to be processed, must be ensured for each sub-beam. A single fixed positioning of the individual sub-beams in relation to each other, and a movement of the workpiece relative to this multi-beam matrix, is usually too slow for a sufficient process throughput. A possible manner for the very dynamic positioning of the multi-beam matrix on the workpiece is therefore required, without compromising the positioning accuracy of the individual beams. The generation of non-periodic structures in the workpiece, non-planar processed surfaces, the processing of edge regions, or the dynamic, localised achievement of specific temperature profiles, can also require the multi-beam matrix to be adjusted during processing. This adjustment can relate to the number of sub-beams, to the arrangement of the sub-beams relative to each other, to the movement vectors of the individual beams in relation to each other, and/or to the shape of the individual sub-beams.

### PRIOR ART

Modern laser positioning systems, with mirrors that can be rotated by way of galvanometers and a focussing optic, enable very dynamic positioning of laser beams with scanning speeds ≥10 m/s at standard focal lengths of up to 200 mm. These systems can also be used in combination with multi-beam matrices, but then only enable the positioning or guidance of the multi-beam matrix as a whole. The plurality of laser beams are usually directed onto the target plane by way of two rotating or tilting mirrors, arranged one behind the other, of a dynamic deflection device, and are guided over the target plane. However, depending on the deflection angle, these systems lead to a distortion of the multi-beam matrix, and thus to positioning errors of the individual beams in the target plane. These positioning errors reduce the achievable precision of the processing process, and/or the throughput, since, for a prescribed precision, the deflection angle of the laser positioning system that can be utilised is severely limited.

From O. Hofmann et al, “Highly dynamic positioning of individual laser beams in a multi-beam system for laser surface processing”, Procedia CIRP 2020; 94:812-816, an optical compensation for the distortion of multi-beam matrices when using modern laser positioning systems with four sub-beams is proposed; this is inserted between the device for the generation of the multi-beam matrix and the dynamic deflection device. It takes the form of a combination of rotatable plane-parallel plates and focus-shifters. However, with this approach, no further adjustments to the multi-beam matrix are possible. An extension of this approach to more than four sub-beams is also not realistic, for reasons of space alone.

Alternatively, a completely separate positioning system could also be used for each individual beam. This enables the precise and independent positioning of the individual beams, but also leads to significantly higher costs, and increased space requirements, and also cannot sensibly be scaled up for a high number of sub-beams.

Furthermore, there are systems of known art for dynamic light and laser beam shaping that enable the generation of almost any power density distribution in a prescribed target plane. The two key technologies in this field are so-called digital micromirror devices (DMD) and liquid crystal systems (liquid crystal (LC) or liquid crystal on silicon (LCOS)), as described, for example, in Texas Instruments, Laser Power Handling for DMD's: DIPA027, available from: www.ti.com/lit/wp/dlpa027/dlpa027.pdf, and in G. Zhu et al, “Thermal and optical performance characteristics of a spatial light modulator with high average power picosecond laser exposure applied to materials processing applications”, Procedia CIRP 2018; 74, 594 to 597.

DMDs consist of a matrix of micromirrors approximately 10 μm in size that can be tilted very dynamically into one of two possible positions. DMDs are generally used such that the light from a light source is projected onto the target (e.g. a screen) in one tilted position, and falls into a beam trap in the other tilted position. Each micromirror corresponds to a pixel of the image- or video-projection, and can be switched on and off independently. To alter the (apparent) brightness of a pixel, the micromirrors can be resonantly tilted at frequencies far above the flicker fusion frequency of the eye, so as to adjust the average brightness of a pixel. However, processes in laser material processing take place on much shorter time scales. Direct laser beam shaping with DMDs is possible, but therefore allows only binary intensity levels for each pixel. As these systems have primarily been developed for video projection, they are generally only suitable for laser powers <150 W, or significantly lower.

Liquid crystal systems utilise the bi-refringent property of liquid crystals to adjust, locally and continuously, the amplitude and/or the phase of the light. By way of an adjustment of the amplitude, a laser beam can be directly shaped, and/or split into a multi-beam matrix. However, this process is subject to losses. Any local reduction in amplitude leads to a loss of the associated light output. The almost loss-free adjustment of the phase of the light is therefore more prevalent. By a skilful adjustment of the phase, the power density distribution can be adjusted in almost any manner in a plane located behind the liquid crystal system. Using so-called diffractive phase distributions, multi-beam matrices with almost any beam positions can also be achieved. With diffractive beam splitting, however, undesirable features almost always occur in the form of unwanted diffraction orders that cannot be completely suppressed. With static beam splitting, these can be filtered out using a mask, for example, although this is not always possible with dynamic beam splitting. Liquid crystal systems are also limited to a maximum repetition rate of 120 Hz. In addition, the determination of the required phase for a desired target distribution is not trivial, and must be carried out for each intermediate distribution or intermediate position with a dynamic adjustment of the power density distribution or the multi-beam matrix.

DE 10 2020 107 760 A1 discloses a laser processing device in which an array of micromirror scanners is used to deflect dynamically the sub-beams. U.S. Pat. No. 6,515,257 B1 uses an array of micromirrors to create through-holes or vias in chips.

The object of the present invention is to provide a method and a device for the independent dynamic positioning of a plurality of laser beams, in particular of individual beams of a multi-beam laser system, on a target plane, with which an independent, very dynamic, positioning is made possible with high positioning accuracy, preservation of the beam quality and, above all, with low space requirements.

### PRESENTATION OF THE INVENTION

The object is achieved with the device and the method in accordance with the patent claims 1 and 9. Advantageous configurations of the device and the method are the subject of the dependent patent claims, or can be extracted from the following description, together with the examples of embodiment.

The proposed device for the independent dynamic positioning of a plurality of laser beams on a target plane has at least one dynamic deflection device, with which the laser beams can be directed onto the target plane, and guided over a respective area of the target plane, and preferably also a device for the generation of the laser beams. The plurality of laser beams can take the form, for example, of the sub-beams of a multi-beam laser system, in which a static optical system splits the laser beam(s) of one or a plurality of laser beam sources into the desired number of sub-beams, The target plane can, for example, be a surface of a workpiece to be processed using laser radiation. The laser beams can, of course, also be generated by a plurality of separate laser beam sources, for example laser diodes, and used without any further beam splitting in the proposed device. In the proposed device, the dynamic deflection device has an arrangement of a plurality of, preferably two-axis, microscanners, which in each case can be controlled independently of one another. The number of microscanners is selected, and the laser beams in the arrangement are guided, such that each laser beam is directed onto the target plane via a different microscanner. The device is characterised by the fact that the microscanners have mirrors with an oval or rectangular mirror shape, in each case with a long and a Short axis, and are arranged such that in a zero position of the microscanners, the long axis of the oval or rectangular mirror shape lies in a plane of incidence of the laser beam that is incident on the respective microscanner.

A microscanner is to be understood to be a micro-opto-electro-mechanical system (MOEMS) from the class of micro-mirror actuators. Here the scanning movement of an individual mirror in preferably two axes is rotational, whereby the mirror can be continuously tilted in the two axes, which are preferably at right-angles to each other, over a range of angles. The lateral dimensions of the mirrors of the individual microscanners lie in the millimetre range. The mirrors of the microscanners in the proposed device preferably have lateral dimensions (length×width) of at least (0.5+x) mm×0.5 mm, and preferably maximum lateral dimensions of 10 mm×(10−x) mm (where x>0). Such microscanners can be tilted very dynamically about the two tilting axes continuously through ≥20°. Microscanners with smaller tilt angles can also be used. With a resonant mode of operation, tilting frequencies of up to 50 kHz can be achieved. Quasi-static operation of at least one axis of the microscanner is also possible, depending on the desired application.

As the microscanners used in the proposed device can be controlled separately, each laser or sub-beam be can positioned on the target plane independently of the others. The microscanners have small dimensions, such that the proposed deflection device can be implemented in a space-saving manner. The microscanners are preferably arranged in an array or matrix of a plurality of rows and columns in one plane, or also in a plurality of stages. In a preferred configuration, the centre-to-centre distances between the mirrors of the individual microscanners in each row and column are, at most, twice the size of the mirrors in the said row or column. By virtue of the resultant small distance between the individual laser beams or sub-beams after passing through the dynamic deflection device, the latter can be focussed into the target plane using a common focussing optic, for example, a single lens common to all sub-beams, if so desired.

By virtue of the independent positioning capability, the device and the associated method can be used to generate any power density distributions in the target plane as adjusted to the process. This applies in particular to contiguous distributions of any shape, which are generated by a partial overlapping of the individual laser beams or sub-beams in the target plane. By virtue of the high-frequency dynamics of the microscanners, these power density distributions can be altered or adjusted very quickly in the course of processing as necessary, for example, when changing the feed direction, the feed speed, the local shape of a workpiece to be processed, or the angle of incidence of the laser beams on the workpiece. This type of very dynamic adaptation of the power density distribution in the target plane enables consistent processing results to be achieved over the entire processing area during the laser material processing of a workpiece.

With the proposed method, in which such a dynamic deflection device is used for dynamic positioning of the laser beams on the target plane, different operating modes can be implemented, which can, of course, also be combined as required, For example, the laser beams can be positioned in the target plane in the form of a multi-beam matrix with fixed beam spacing, and dynamically guided over the target plane. The microscanners are controlled such that the laser beams form a pattern, or a power density distribution, in the target plane, which is guided over at least one area of the target plane without alteration. The laser beams can, for example, form a matrix of columns and rows of laser beams, in which neighbouring laser beams of each row and neighbouring laser beams of each column are at a constant distance from each other. Distortions of the multi-beam matrix, caused, for example, by the focussing optic, or tilted or curved target planes, can be compensated for directly by way of the microscanner. Depending on the application, dynamic and completely independent positioning and movement of the sub-beams in the target plane can also be achieved. In this way, the sub-beams can be used to process a prescribed geometry independently of each other: Each sub-beam processes an element of the overall geometry. Furthermore, the method enables the targeted generation, adjustment, and positioning of power density distributions in the target plane by the lining up in series, and/or the overlapping, of the sub-beams.

The device for the generation of the laser beams-as an optional component of the proposed device-is preferably designed such that it emits at least four laser beams, which are directed onto the target plane by way of the dynamic deflection device. Here the device can be scaled as required, that is to say, the number of laser beams generated and deflected can easily be increased by an appropriate configuration of the device for the generation of the laser beams, and an enlargement of the array of microscanners accordingly,

In an advantageous configuration, in which the individual laser beams represent sub-beams that are generated from a laser beam source with a suitable beam splitting device, there is preferably an optical device between the beam splitting device and the dynamic deflection device for purposes of parallelisation—and if necessary, also collimation—of the laser beams, such that they impinge on the array of microscanners at the same angle. Typically, diffractive beam splitting devices do not initially generate any parallel sub-beams.

In the proposed device and the proposed method, the mirrors of the microscanners in one alternative have an oval shape, whereby the microscanners are orientated such that the long axis of the oval shape lies in the plane of incidence of the particular laser beams when the microscanners are in a zero position (that is to say, when the mirrors are not in a deflected state). By this means the microscanners can be positioned closer together, at right-angles to the plane of incidence, than would be the case with circular or square mirrors. Instead of the oval shape, a corresponding rectangular shape, with pointed or rounded edges, and with a greater length than width, can also be used in the same manner.

The proposed device and the associated method enable the very dynamic, independent and scalable positioning of a plurality of laser beams or sub-beams of a multi-beam system. In comparison to solutions with a plurality of separate laser positioning systems, the device is cost-efficient, as microscanners are already more cost-effective than galvanometer-based 2D deflection devices. In many cases, the proposed device and the associated method can also be operated with just a single focussing optic, that is to say, an optical lens or lens combination common to all the laser beams or sub-beams. Furthermore, there is an analytical, and often in fact a linear, relationship between the deflection angles of the particular micromirror and the beam position in the target plane. This means that the required deflection angles can be calculated directly from the desired beam positions. Time-consuming optimisation for all possible combinations of individual beam positions, as is the case for diffractive approaches, is therefore not necessary with the present invention. The proposed device allows significantly shorter switching times compared to the liquid crystal systems of known art,

The targeted illumination of the individual microscanner mirrors also prevents heating and damage to the electronics under or between the mirrors. In addition, the microscanner mirrors can be provided with modern reflective coatings in order to increase the usable laser power further. In contrast, the individual mirrors in DMDs are made of polished metal, usually and aluminium, therefore only achieve reflectivity levels of around 90%, which significantly reduces the usable laser power. The proposed device and the associated method therefore also enable dynamic laser beam shaping at laser powers that significantly exceed the damage threshold of beam shaping elements such as DMDs or liquid crystal systems.

### BRIEF DESCRIPTION OF THE FIGURES

The proposed device and the associated method are explained again in more detail below using examples of embodiments in conjunction with the figures. Here:

FIG. 1 shows a schematic representation of the basic structure of a configuration of the proposed device;

FIG. 2 shows an example of the generation of a plurality of laser beams in the proposed device by way of a beam splitter;

FIG. 3 shows an example of the generation of a plurality of laser beams in the proposed device by way of a mask; and

FIG. 4 shows three examples of the positioning and movement of the laser beams in a target plane using the proposed method.

### PATHS TO THE IMPLEMENTATION OF THE INVENTION

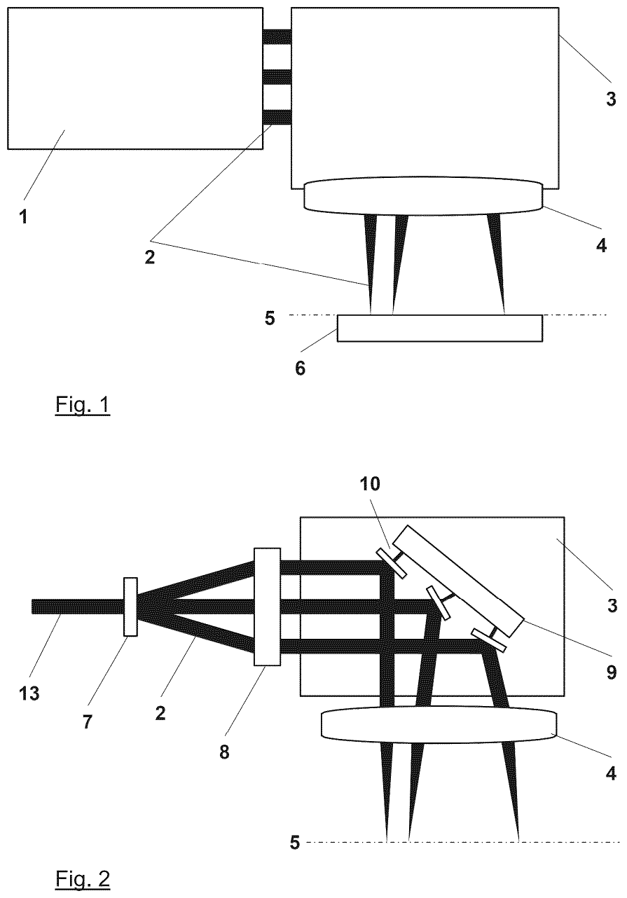

An example of the basic structure of the proposed device is presented in FIG. 1. The device has an (optional) device 1 for the generation of a plurality of laser beams 2, a dynamic deflection device 3 for the dynamic two-dimensional deflection of the laser beams, and-if required-a focussing optic 4. The dynamic deflection device 3 is used to direct the laser beams 2 onto the target plane 5, and to guide them over this target plane, which in this example represents the surface of the substrate 6 shown, for example, a workpiece that is to be processed. The focussing optic serves to focus the laser beams onto the target plane as required.

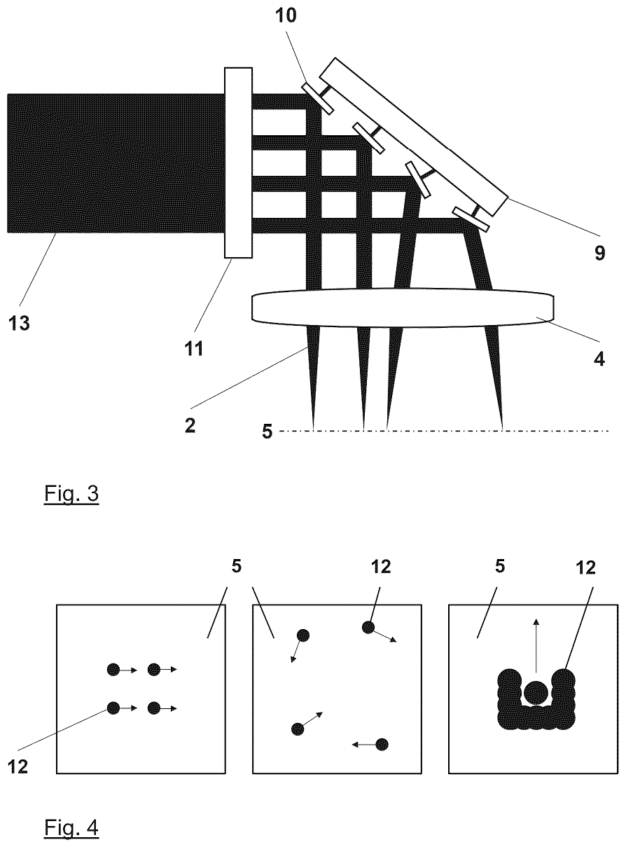

In the present device, a plurality of laser beams can be generated either by using a plurality of lasers, for example semiconductor lasers, or also by using just one laser (or a plurality of lasers), whose laser beam (or beams) is/are split into a plurality of sub-beams by way of a beam splitting device. FIG. 2 shows an example in which the device 1 for the generation of a plurality of laser beams is formed by a laser (not shown in this depiction) and an adjoining beam splitter 7, which splits the laser beam 13 of the laser into the desired number of sub-beams 2. In the present example, this beam splitter 7 takes the form of a static optical system, for example a diffractive optical element as in FIG. 2, or a mask as in FIG. 3. Alternatively, a dynamically adaptable beam splitter (e.g. LCOS) is also possible, which can be used, for example, to switch individual beams on and off, with significantly lower frequency dynamics, such as those of the deflection device. In the case of the diffractive optical element in FIG. 2, the generated sub-beams 2 do not run in parallel, and are suitably aligned in parallel by way of an optical device 8, and are directed onto the dynamic deflection device 3. In the proposed device, this dynamic deflection device 3 is formed by a microscanner matrix 9, as indicated in FIGS. 2 and 3. Here each sub-beam 2 is preferably centred on one of the microscanners 10, or on its two-dimensional, continuously tiltable mirror, In FIGS. 2 and 3, the sheet plane represents the plane of incidence. In these examples, the micromirrors of the microscanners 10 have a rectangular shape, whose long axis lies in the said plane of incidence. In the direction at right-angles to the sheet plane, the micromirrors then have a smaller dimension, The presentation in FIGS. 2 and 3 is only schematic, so that the small distances between the microscanners 10 are not shown. The individual microscanners can here be controlled independently of each other. Further optical elements, for example, for purposes of focussing the multi-beam matrix in the target plane 5, can be arranged downstream of the microscanner matrix 9. FIGS. 2 and 3 show a common focussing optic 4 for this purpose.

When using a 11 splitting, shown mask for beam as schematically in FIG. 3, a device for the parallelisation of the individual sub-beams 2 can generally be dispensed with, as the latter already run parallel to each other. The laser beam 13 from the laser beam source is suitably widened and appropriately collimated before it impacts the mask 11, as indicated by the shape of the laser beam 13 in FIG. 3.

With the aid of the individual microscanners 10, each sub-beam 2 can be positioned and moved very dynamically in the target plane 5, independently of the other sub-beams 2, using the proposed device and the associated method. The number of sub-beams 2 generated is not limited to the number shown in the figures. FIGS. 2 and 3 show 3 and 4 sub-beams in the sheet plane, but in the case of a rectangular matrix with the same number of mirrors in each row and column, they actually generate nine and sixteen sub-beams in the space respectively. This number can be scaled up as desired, with the appropriate generation of a larger number of sub-beams, by means of an increase in the number of microscanners 10 in the microscanner matrix 9. The generation of sub-beams for a non-rectangular matrix is, of course, also possible.

The device can be operated in different operating modes, which can also be combined as desired. FIG. 4 shows three highly schematised operating modes in which the laser spots 12 generated on the target plane 5 and their exemplary directions of movement are indicated. In the first picture in this figure, a dynamic positioning of a multi-beam matrix consisting of four sub-beams, with fixed distances between the beams, is taking place in the target plane. Distortions of the multi-beam matrix, caused, for example, by the focussing optic, or tilted or curved workpiece surfaces, can also be compensated for during the movement indicated by the arrows of this multi-beam matrix in the target plane.

The central picture in the figure shows an operating mode in which the individual sub-beams, or laser spots 12, are positioned dynamically, and completely independently of each other, and are moved in the target plane. The movement is again indicated by the exemplary arrows. This means that the sub-beams can be used independently of each other to process a prescribed geometry together, whereby each sub-beam is used to process an element of the overall geometry.

Targeted generation, adaptation and positioning of power density distributions in the target plane can also be achieved by the lining up in series, and/or the overlapping, of the sub-beams and their laser spots 12 in the target plane 5, as schematically indicated in the right-hand picture in the figure. The power density distribution generated there by the lining up in series, and/or the partial overlapping, of the laser spots 12 of a large number of laser beams, for example so as to achieve specific temperature profiles, can then be moved across the target plane in the direction indicated by the arrow, for example, and also modified, as required, during the movement.

### LIST OF REFERENCE SYMBOLS

1 Device for the generation of a plurality of laser beams
2 Laser beams, or sub-beams
3 Dynamic deflection device
4 Focussing optic
5 Target plane
6 Substrate
7 Beam splitter
8 Optical device for parallelisation
9 Microscanner matrix
10 Microscanner
11 Mask
12 Laser spot
13 Laser beam

1. A device for the dynamic positioning of a plurality of laser beams (2) on a target plane (5), which has at least one dynamic deflection device (3), with which the laser beams (2) can be directed onto the target plane (5) and guided over a respective region of the target plane (5), wherein
the dynamic deflection device (3) has an arrangement (9) of a plurality of single-axis and/or dual-axis microscanners (10), each of which can be controlled independently of one another, wherein
the number of microscanners (10) is selected and the laser beams (2) in the arrangement are guided such that each laser beam (2) is directed onto the target plane (5) by way of a different microscanner (10),
characterised in that,
the microscanners (10) have mirrors with an oval or rectangular mirror shape, and are arranged such that, in a zero position of the microscanners (10), a long axis of the oval or rectangular mirror shape lies in a plane of incidence of the laser beam (2) that is incident on the particular microscanner (10).

2. The device in accordance with claim 1,
characterised in that,
the device has a device (1) for the generation of the laser beams (2).

3. The device in accordance with claim 2,
characterised in that,
the device (1) for the generation of the laser beams is designed such that it emits at least four laser beams (2), which are directed onto the target plane (5) by way of the dynamic deflection device (3).

4. The device in accordance claim 1,
characterised in that,
the microscanners (10) are arranged in an array-or matrix-shaped arrangement of a plurality of rows and columns, such that the centre-to-centre distances of the mirrors of the individual microscanners in each row and column are, at most, twice the extent of the mirrors in the said row or column.

5. The device in accordance with claim 2,
characterised in that,
the device (1) for the generation of the laser beams is formed from a plurality of laser beam sources that are arranged next to one another.

6. The device in accordance with claim 2,
characterised in that,
the device (1) for the generation of the laser beams has one or a plurality of laser beam sources, and one or a plurality of beam splitting devices (7, 11).

7. The device in accordance with claim 2,
characterised in that,
an optical device (8) for the parallelisation of the laser beams (2) is arranged between the device (1) for the generation of the laser beams and the dynamic deflection device (3).

8. The device in accordance with claim 1,
characterised in that,
a focussing optic (4) that is common to all laser beams (2) is arranged between the dynamic deflection device (3) and the target plane (5).

9. A method for the dynamic positioning of a plurality of laser beams (2) on a target plane (5), in which the laser beams (2) are directed onto the target plane (5), using the dynamic deflection device (3) in accordance with claim 1, wherein
the number of microscanners (10) is selected, and the laser beams (2) are guided by way of the dynamic deflection device, such that each laser beam (2) is directed onto the target plane (5) by way of a different microscanner (10).

10. The method in accordance with claim 9,
characterised in that,
the microscanners (10) are controlled such that the laser beams (2) form a pattern or a power density distribution in the target plane (5), which is guided over at least one area of the target plane (5) without alteration.

11. The method in accordance with claim 10,
characterised in that,
the laser beams (2) form a matrix of columns and rows of laser beams in the target plane (5), in which neighbouring laser beams of each row and neighbouring laser beams of each column have the same distance between one another.

12. The method in accordance with claim 9,
characterised in that,
the microscanners (10) are controlled such that the laser beams (2) are guided over the target plane (5) completely independently of one another.

13. The method in accordance with claim 9,
characterised in that,
the microscanners (10) are controlled such that the laser beams (2) form a pattern or a power density distribution in the target plane (5), which alters in accordance with a specification during the guidance of the laser beams (2) over the target plane.
